(19) United States
(12) Patent Application Publication
(10) Pub. No.: US 2022/0161786 A1
(43) Pub. Date: May 26, 2022

(54) SYSTEM FOR EVALUATING RISK VALUES ASSOCIATED WITH OBJECT ON ROAD FOR VEHICLE AND METHOD FOR THE SAME

(71) Applicants: HYUNDAI MOTOR COMPANY, SEOUL (KR); KIA MOTORS CORPORATION, SEOUL (KR)

(72) Inventor: Bilal JAVAID, Ada, MI (US)

(73) Assignees: HYUNDAI MOTOR COMPANY, SEOUL (KR); KIA MOTORS CORPORATION, SEOUL (KR)

(21) Appl. No.: 17/103,380

(22) Filed: Nov. 24, 2020

(51) Int. Cl. B60W 30/09; G08G 1/16; B60W 30/095; B60W 60/00; G06N 20/00; G06N 5/04

(52) U.S. Cl. CPC B60W 30/09; G08G 1/16; B60W 30/0956; B60W 60/0015; B60W 2554/20; G06N 20/00; G06N 5/04; B60W 2554/4029; B60W 2554/404; B60W 60/0011

(57) ABSTRACT

A system for evaluating a risk value associated with an object on the road and a method for the same are provided. The method may include detecting, by a plurality of sensors, an object on a road that a vehicle travels, wherein each sensor of the plurality of sensor is configured to detect different types of the object; after detecting the object on the road, classifying, by a processor, the object into an object type; identifying, by the processor, a plurality of maneuvering options of the vehicle corresponding to the object type; calculating, by the processor, risk values of each maneuvering option; and selecting, by the processor, a maneuvering option, wherein a risk value of the selected maneuvering option is equal to or less than a predetermined risk value.

### TECHNICAL FIELD

The present disclosure relates to a system and method for evaluating a risk value of an object on a road that a vehicle travels.

### BACKGROUND

The statements in this section merely provide background information related to the present disclosure and may not constitute prior art.

Over the past decade, autonomous vehicles have evolved at a very noticeable pace. Similarly, artificial intelligence and machine learning have been developed and used in many technologies. In some situations, an autonomous vehicle may be combined with several machine learning models to implement certain features of autonomous driving technology.

### SUMMARY

The present disclosure provides an autonomous vehicle with an opportunity to drive through an object on the road without avoiding the object or to make a complete stop before the object.

In one aspect of the present disclosure, a method may include: detecting, by a plurality of sensors, an object on a road that a vehicle travels, wherein each sensor of the plurality of sensors may be configured to detect different types of the object; after detecting the object on the road, classifying, by a processor, the object into an object type; identifying, by the processor, a plurality of maneuvering options of the vehicle corresponding to the object type; calculating, by the processor, risk values of each maneuvering option; and selecting, by the processor, a maneuvering option of the plurality of maneuvering options, wherein a risk value of the selected maneuvering option is equal to or less than a predetermined risk value.

In another aspect of the present disclosure, a system may include: a plurality of sensors operatively connected to a processor, wherein the plurality of sensors is configured to detect an object on a road that a vehicle travels; detect a material of the object; and detect surrounding vehicles and structures. The system may also include non-transitory memory storing instructions executable to evaluate risk values of each maneuvering option of a plurality of maneuvering options. In addition, the system may include the processor configured to execute the instructions to classify the object into an object type; identify a plurality of maneuvering options of the vehicle corresponding to the object type; calculate the risk values of the each maneuvering option; and select a maneuvering option, wherein a risk value of the selected maneuvering option is equal to or less than a predetermined risk value.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows an exemplary electronic communication environment for implementing a system that evaluates risk values of multiple maneuvering options for a vehicle when an object on the road is detected in one form of the present disclosure;

FIG. 2 shows an illustration of how the system works when the object on the road is detected in one form of the present disclosure;

FIG. 3 show a flow diagram of a method for evaluating the risk values of each maneuvering option for the vehicle in one form of the present disclosure;

FIG. 4 shows features necessary to calculate the risk values of driving through the object in one form of the present disclosure;

FIG. 5 shows an exemplary form of calculating the risk values of driving through the object;

FIG. 6 shows a flow diagram of a method for calculating weight parameters using a machine learning model in one form of the present disclosure; and

FIG. 7 shows a flow diagram of another exemplary method for evaluating the risk values of driving through the object in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Throughout this specification and the claims which follow, unless explicitly described to the contrary, the word “comprise” and variations such as “comprises” or “comprising” will be understood to imply the inclusion of stated elements but not the exclusion of any other elements.

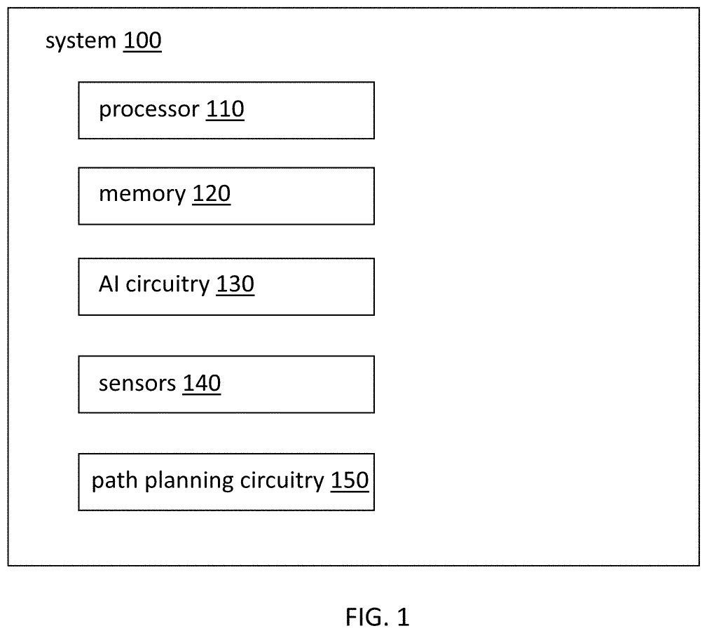

FIG. 1 shows an exemplary electronic communication environment for implementing a system that evaluates risk values of multiple maneuvering options for a vehicle when an object on the road is detected in some forms of the present disclosure.

The system 100 may include the following components: a processor 110, memory 120, artificial intelligence (“AI”) circuitry 130, a plurality of sensors 140, and path planning circuitry 150.

The processor 110 may refer to a hardware device capable of executing one or more steps. Examples of the processor 110 may include, but are not limited to, a field-programmable gate array (FPGA), any integrated circuit (IC) and programmable read-only memory (PROM) chips. The memory 120 may be configured to store algorithmic steps and the processor 110 is specifically configured to execute the algorithmic steps to perform one or more processes which are described further below.

Furthermore, the processor 110 executing the algorithmic steps may be embodied as non-transitory computer readable media on a computer readable medium containing executable program instructions executed by a processor, a controller, or the like. Examples of computer readable media include, but are not limited to, ROM, RAM, compact disc (CD) ROMs, magnetic tapes, floppy disks, flash drives, smart cards, and optical data storage devices. The computer readable recording medium can also be distributed in network coupled computer systems so that the computer-readable media are stored and executed in a distributed fashion.

The AI circuitry 130 may identify the best performing machine learning model, which may be based on how similar output is to driving data collected by a human driver. In calculating an evaluation score, Silhouette Score may be used. Silhouette Score may refer to a measure of how similar an object is to its own cluster, and it may range from −1 to +1, where a high value indicates that the output is well matched to the driving data. If most of the output has a high value, then the configuration of the machine learning model may be appropriate. For example, a machine learning model with the highest Silhouette Score may indicate the optimal machine learning model for output. Based on the evaluation score, the processor 110 may derive an optimal number of driving data.

A plurality of sensors 140 may be able to detect (i) a type of an object on the road such as a tire tread, a plastic bag, a mattress, and the like; and (ii) material of the object such as a Styrofoam, a soft/hard plastic, wood, metal, and the like depending on a type of the sensors being used. Additionally or alternatively, the plurality of sensors 140 may be standalone or used along with a plurality of cameras to determine an object type and/or an object material with higher accuracy. In some forms of the present disclosure, different types of sensors 140 may be used, including but not limited to, a LiDAR sensor, a wireless magnetometer, a wireless ultrasonic sensor, a radar sensor, an optical sensor, an infrared sensor, a time-of-flight (ToF) sensor, a thermal sensor, and measuring light grid.

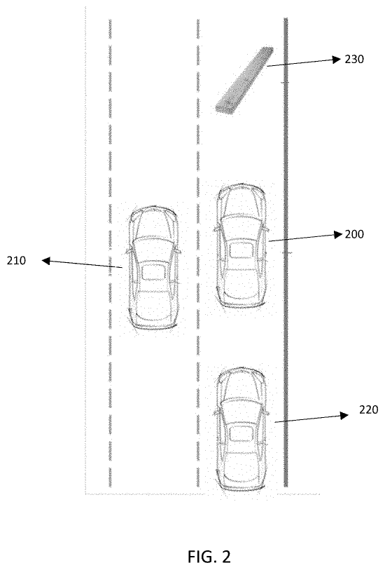

The path planning circuitry 150 may set a path for a vehicle 200 (shown in FIG. 2) according to the maneuvering option selected by the processor 110. Depending upon the maneuvering option selected by the processor 110 (will be described in FIG. 2 below), the path may be adjusted.

FIG. 2 shows an illustration of how the system works when the object on the road is detected in some forms of the present disclosure.

When the plurality of sensors 140 of the vehicle 200 detect an object 230 on a road that the vehicle 200 is traveling, there are several options from which the vehicle 200 can choose. First, the vehicle 200 may decide to come to a complete stop to avoid a collision with the object 230. This option may be available to the vehicle 200 when (i) the object 230 is big (e.g., mattress, furniture, and the like) or may be a serious threat to the vehicle 200 such that driving through the object 230 in lieu of a full stop would damage the vehicle 200, or (ii) changing a lane is impossible when the vehicle 200 is traveling right next to a surrounding vehicle 210. In some forms of the present disclosure, this option may also be available to the vehicle 200 when a safety distance between the vehicle 200 and a following vehicle 220 is maintained even if the vehicle 200 makes a quick stop before the object 230.

The second option may be determining a new path to avoid the collision with the object 230 when the vehicle 200 is safe to do so (e.g., no surrounding vehicle 210 is present, enough distance before reaching the object 230 for the following vehicle 220 to take a proper action). The system 100 may evaluate each of the first option and the second option individually or collectively and compare each other to determine the best option for the vehicle 200 with a minimum risk.

The third option may be for the vehicle 200 to go through the object 230 without swerving into another lane or making a stop. This option may be ideal when the object 230 is very small (e.g., a small plastic bag, a small piece of wood) or a material of the object 230 is soft (e.g., Styrofoam). Under certain circumstances, this option may be selected when there is a foreseeable risk associated with swerving into another lane or making a stop (e.g., the surrounding vehicle 210 is present, or the following vehicle 230 is too close to the vehicle 200).

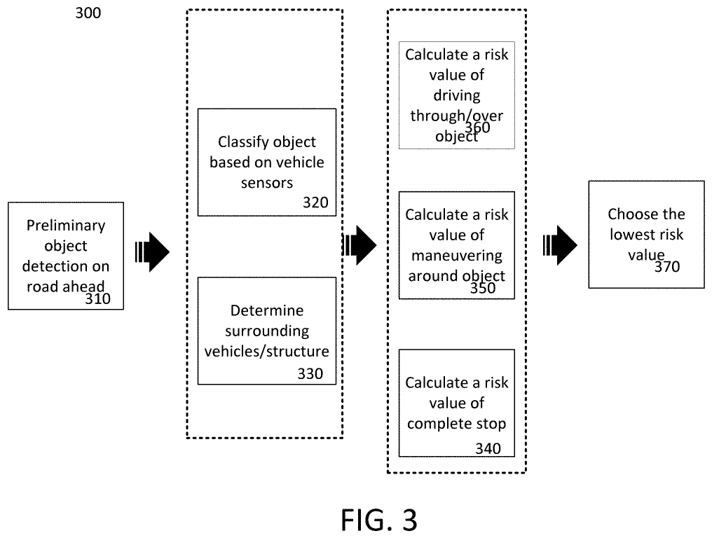

FIG. 3 shows a flow diagram 300 of a method for evaluating the risk values of each maneuvering option for the vehicle in some forms of the present disclosure.

At 310: the plurality of sensors 140 may detect the object 230 on the road that the vehicle 200 is traveling. Depending on the type of sensors equipped in the vehicle 200, different types of objects may be detected. Additionally or alternatively, a certain type of sensors may detect a material type of the object 230 (e.g., Styrofoam, plastic, wood, metal, and the like).

At 320: the processor 110 may classify the object 230 into an object type (e.g., tire tread, plastic bag, mattress, and the like). Additionally or alternatively, the processor 110 may also classify the object 230 into a material type (e.g., Styrofoam, plastic, wood, metal, and the like).

At 330: the processor 110 may identify a plurality of maneuvering options of the vehicle 200 based on surrounding vehicles 210 and following vehicles 220 as well as structures detected by the plurality of sensors 140. The plurality of maneuvering options of the vehicle 200 may include (i) a first maneuvering option of determining a new trajectory of the vehicle 200 to avoid contact with the object 230, (ii) a second maneuvering option of controlling the vehicle 200 to a full stop before the object 230, and (iii) a third maneuvering option of driving the vehicle 200 through the object 230.

At 340: after the plurality of maneuvering options of the vehicle 200 is identified, the processor 110 may calculate a risk value of the second maneuvering option.

At 350: similarly, the processor 110 may calculate a risk value of the first maneuvering option.

At 360: the processor 110 may calculate a risk value of the third maneuvering option.

At 370: the processor 110 may compare each risk value of the first maneuvering option, the second maneuvering option, and the third maneuvering option, respectively, and then select a maneuvering option having the lowest risk value. In particular, when selecting the third maneuvering option, the processor 110 may receive additional object information (e.g., the size of the object 230, whether the object 230 is moving, whether the object 230 is a living material) from the plurality of sensors 140. In some forms of the present disclosure, the size of the object 230 may be a critical factor in selecting the third maneuvering option. Specifically, the processor 110 may determine whether the size of the object 230 is smaller than a predetermined size. If the size of the object 230 is smaller than the predetermined size, then the third maneuvering option may be selected.

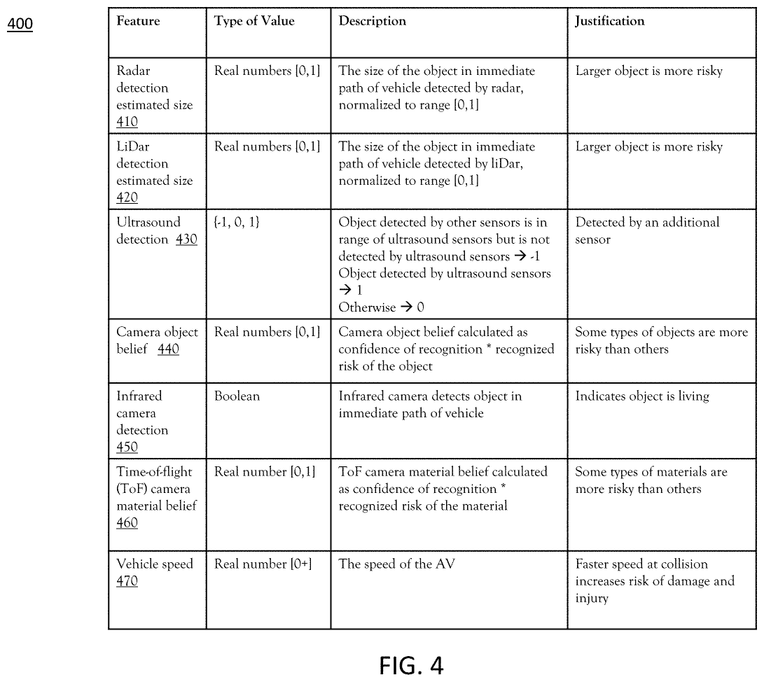

FIG. 4 shows table 400 showing a list of features necessary to calculate the risk values of driving through the object in some forms of the present disclosure.

In 410, the size of the object 230 detected by a radar sensor may be converted into a normalized value ranging from 0 to 1. The larger the object 230 is, the greater the normalized value becomes as the large object presents more risk to the vehicle 200. For example, if the size of the object 230 is very insignificant and risk-free, the normalized value may be 0 as described in 510.

Similar to 410, in 420, the size of the object 230 detected by a LiDar sensor may be converted into a normalized value ranging from 0 to 1. The larger the object 230 is, the greater the normalized value is as the large object is riskier to the vehicle 200. In 520, the normalized value is indicated as 0.2.

In 430, the object 230 detected by an ultrasound sensor may be converted into a normalized value. For example, −1 may be assigned to the object detected by other sensors, but not detected by the ultrasound sensor. On the other hand, the object 230 detected by the ultrasound sensor may have a normalized value of 1. If the object 230 is undetected by any of the plurality of sensors 140, the normalized value may be 0. In 530, the normalized value is 0 as the object 230 was not detected by any of the plurality of sensors 140.

In 440, a camera object belief may have a normalized value ranging from 0 to 1 depending upon the object type (e.g., tire tread 0.4, plastic bag 0.1, mattress 0.7). For example, in 540, the camera object belief may have the normalized value of 0.2. In some forms of the present disclosure, the camera object belief may be calculated by multiplying confidence of recognition with a recognized risk of the object. Here, the confidence of recognition may be represented with real numbers ranging from 0 to 1, and an object recognition algorithm may give confidence value for recognized objects. On the other hand, the recognized risk of the object, which also may be represented with real numbers ranging from 0 to 1, may be determined from a lookup table of common roadway objects having a predetermined risk value for each object. As an example, the following lookup table may be used.

| Object Type | Risk |
|---|---|
| Tire tread | 0.4 |
| Plastic bag | 0.1 |
| Mattress | 0.7 |

In 450, the object 230 detected by an infrared camera may have a normalized value of 0 or 1. For example, if the object 230 is a living object (e.g., animal, pedestrian, and the like), the normalized value may be 1. Conversely, if the object 230 is a non-living object (e.g., tire tread, mattress, furniture, and the like), the normalized value may be 0. In 550, the normalized value may be 0, indicating that the object 230 is the non-living object.

In 460, a time-of-flight (ToF) camera material belief may have a normalized value ranging from 0 to 1 depending upon the material type of the object 230 (e.g., Styrofoam 0.2, soft plastic 0.1, hard plastic 0.3, wood 0.6, metal 0.9). For example, in 560, the ToF camera material belief may have a normalized value of 0.5.

Here, the Time-of-Flight (TOF) camera material belief may be calculated by multiplying confidence of recognition with a recognized risk of the material. Here, the confidence of recognition may be represented with real numbers ranging from 0 to 1, and an object recognition algorithm may give confidence value for recognized objects. On the other hand, the recognized risk of the material, which also may be represented with real numbers ranging from 0 to 1, may be determined from a lookup table of common roadway object materials having a predetermined risk value for each object material. As an example, the following lookup table may be used.

| Material Type | Risk |
|---|---|
| Styrofoam | 0.2 |
| Soft plastic | 0.1 |
| Hard plastic | 0.3 |
| Wood | 0.6 |
| Metal | 0.9 |

In 470, vehicle speed may be an important feature when calculating the risk value of the third maneuvering option. Generally speaking, high speed at collision with the object 230 may increase the risk of damage to the vehicle 200 and injury to a driver and passengers. In 570, the vehicle speed may be identified as an actual speed of the vehicle 200, which is 20 miles/hour.

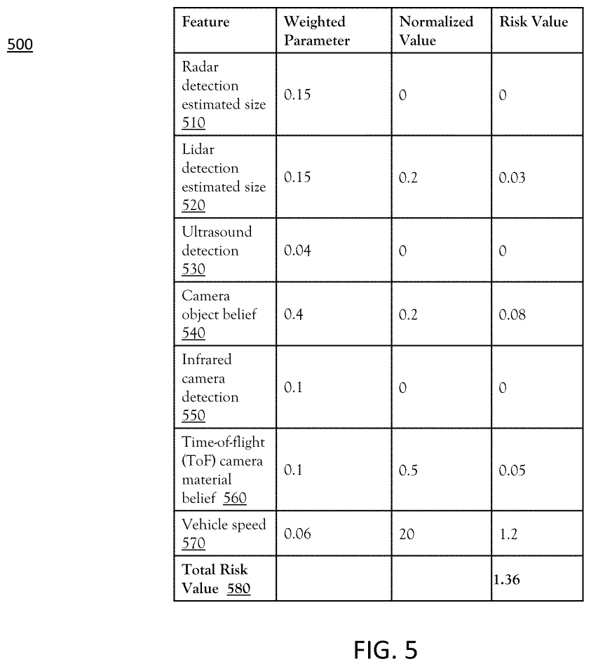

FIG. 5 shows an exemplary table 500 of calculating the risk values of driving through the object.

In each feature, a corresponding risk value may be calculated by multiplying a normalized value (discussed in view of FIG. 4) with a weighted parameter associated with each feature. Here, the normalized value associated with a particular feature may be referred to as a first value, and the weighted parameter associated with a particular feature may be referred to as a second value. Referring to 540, the risk value associated with the camera object belief may be calculated by multiplying the normalized value of 0.2 and the weighted parameter of 0.4, which may yield 0.08. As such, a total risk value of the third maneuvering option may be a sum of each risk value of each feature, which may yield 1.36. The total risk value of the third maneuvering option, which is 1.36 in this example, may be compared with a total risk value of the first maneuvering option and/or the second maneuvering option. Assuming the total risk value of the second maneuvering option is 2.00, then the processor 110 may select the third maneuvering option, which may subsequently control the vehicle 200 to drive through the object 230 because the third maneuvering option has the lowest risk value, and thus, it is the best available decision. In some forms of the present disclosure, the processor 110 may determine a more precise plan of driving through the object 230.

In sum, the following equation to calculate the total risk value of the third maneuvering option may be used.

y=θ^{T}x
where y may be the total risk value;
x may be a vector of relevant features (exemplary features are shown in FIGS. 4 and 5); and
θ may be a vector of the weighted parameters associated with each feature. With N number of features, the equation may expand to as follows:

y=θ₁x₁+θ₂x₂+θ₃x₃+ . . . +θ_{N}x_{N}

Here, the features may be based on detecting the object 230 by a different type of sensor 140. However, if a specific sensor listed in FIG. 5, for example, an infrared sensor in 550, is absent, then the infrared sensor may be removed from the list and may not be used in calculating the risk value. In some forms of the present disclosure, additional sensors relevant to calculating the risk value may be added, and the exemplary list in FIG. 5 may also be expanded accordingly to include features calculated from the added sensors.

One advantage of using this equation with the sum of each risk value associated with each feature where each risk value is calculated by multiplying the normalized value (first value) with the weighted parameter (second value) is that it does not require excessive processing power to perform the calculation. As a result, the processor 110 may use less processing power when calculating the total risk value associated with all present features, thereby contributing to the vehicle 200's overall system efficiency as the processing power is generally limited on the vehicle 200.

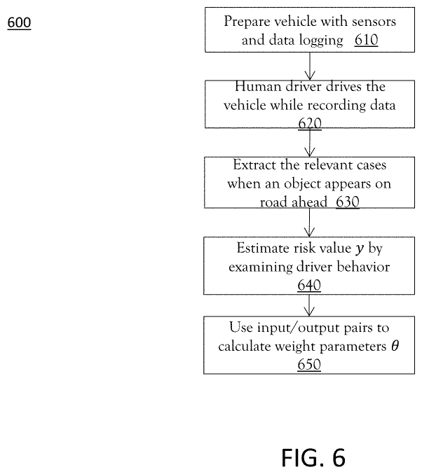

θ may be a vector of the weighted parameters associated with each feature. In some forms of the present disclosure, it may be determined by training a machine learning model from real driving data, which will be explained with reference to FIG. 6.

FIG. 6 shows a flow diagram 600 showing a method of calculating weight parameters using a machine learning model in some forms of the present disclosure.

At 610: Prepare the vehicle 200 with the plurality of sensors 140 and data logging.

At 620: A human driver may drive the vehicle 200 and record relevant data (e.g., driving data) while driving. After the human driver drives the vehicle 200 for a sufficient amount of time, there may be numerous cases where the object 230 appears on the road that the vehicle 200 is traveling.

At 630: These cases (the object 230 appears on the road) may be extracted from the data and used to estimate y, which is the total risk value of selecting the third maneuvering option considering all features. Additionally or alternatively, the total risk value of y may not be directly known. Instead, y may be estimated based on other relevant risk values and a final decision of a user.

At 640: Estimate y (the total risk value of selecting the third maneuvering option considering all features) by examining the behavior of a driver.

At 650: θ may be calculated using input/output pairs, also known as supervised learning. Additionally or alternatively, other machine learning model may be used when calculating the vector of the weighted parameters. For example, a set of driving data to evaluate the performance of each machine learning models of a plurality of machine learning models may be provided to the AI circuitry 130. The AI circuitry 130 may have executed the plurality of machine learning models that had been trained with the driving data. Then, the AI circuitry 130 may select a machine learning model satisfying a predetermined criterion. Once the machine learning model is selected, the second value may be calculated using the selected machine learning model. In some forms of the present disclosure, the machine learning model may be trained. For example. the first set of driving data collected from a server may be received. Then, a first training set including the first set of driving data may be created. Using the first training set, a machine learning model may be trained in the first stage. After the first stage, a second training set including a second set of driving data that has been incorrectly detected as the first set of driving data in the first stage may be created. Using the second training set, the machine learning model may be trained in a second stage.

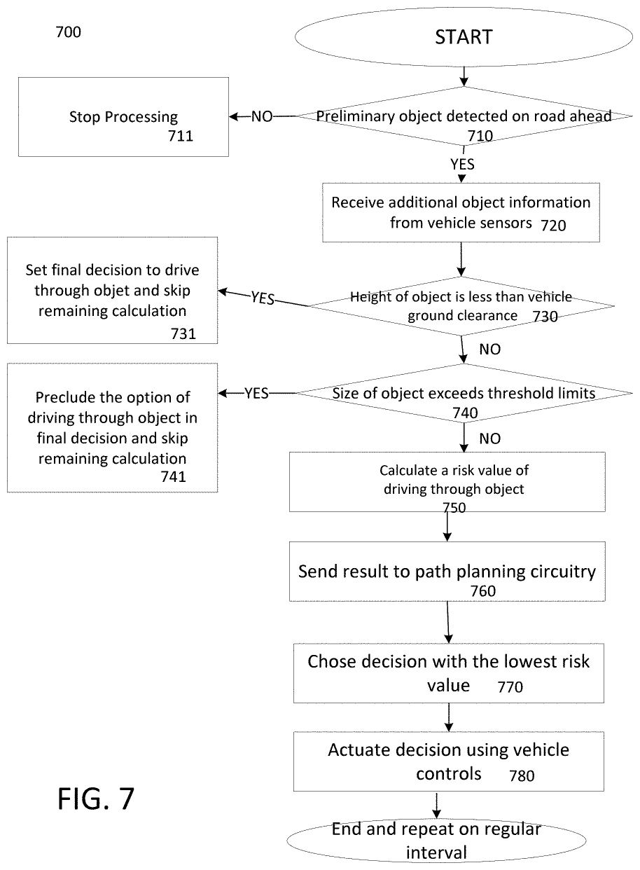

FIG. 7 shows a flow diagram 700 of another exemplary method for evaluating the risk values of driving through the object in some forms of the present disclosure.

At 710: The plurality of sensors 140 may detect the object 230 on the road that the vehicle 200 is traveling. The plurality of sensors 140 as used herein may be able to detect (i) a type of the object 230 such as a tire tread, a plastic bag, a mattress, and the like; and (ii) material of the object 230 such as a Styrofoam, a soft/hard plastic, wood, metal, and the like depending on a type of the sensors being used. Additionally or alternatively, the plurality of sensors 140 may be used along with a plurality of cameras to determine an object type and/or an object material with higher accuracy. In some forms of the present disclosure, different types of sensors 140 may be used, including but not limited to, a LiDAR sensor, a wireless magnetometer, a wireless ultrasonic sensor, a radar sensor, an optical sensor, an infrared sensor, a time-of-flight (ToF) sensor, a thermal sensor, and measuring light grid.

At 711: If the plurality of sensors 140 does not detect any object 230, then the processor 110 may stop calculating a risk value associated with each of the maneuvering options, and control the vehicle 100 to continue traveling on the road until the plurality of sensors 140 detects the object 230.

At 720: The plurality of sensors 140 may transmit, to the processor 110, additional object information (e.g., the size of the object 230, whether the object 230 is moving, and whether the object 230 is a living material, and the like).

At 730: Once the processor 110 receives the additional object information, the processor 110 may determine whether the height of the object 230 is less than a vehicle ground clearance, which may be predetermined.

At 731: If the processor 110 determines that the height of the object 230 is less than a predetermined vehicle ground clearance, then the processor 110 may control the vehicle 200 to drive through the object 230 without calculating the risk value of the third maneuvering option. When the height of the object 230 is insignificant enough to cause no damage to the vehicle 200 at all, there is no need to calculate the risk value of the third maneuvering option, which is to drive the vehicle 200 through the object 230. In that instance, the vehicle 200 may freely drive through the object 230.

At 740: On the other hand, the height of the object 230 is greater than or equal to the predetermined vehicle ground clearance, then the processor 110 may determine the size of the object 230 is greater than or equal to a predetermined threshold size.

At 741: If the processor 110 determines that the size of the object 230 is greater than or equal to the predetermined threshold size, the processor 110 may opt out of selecting the third maneuvering option without calculating the risk value of driving through the object 230 as it may cause severe damage to the vehicle 200. For example, if a mattress is detected, the height of which may be less than the predetermined vehicle ground clearance, the vehicle 200 still may not drive through the mattress as there is a high possibility that it may cause damage to the vehicle 200. Instead, the processor 100 may select either the first maneuvering option or the second maneuvering option depending on the circumstances (e.g., whether the surrounding vehicle 210 is present, and the following vehicle 220 is driving closely to the vehicle 200).

At 750: Once the processor 110 determines that the size of the object 230 is less than the predetermined threshold size, the processor 110 may calculate the risk value of driving the vehicle 200 through the object 230 (third maneuvering option) associated with all features as discussed in view of FIG. 5.

At 760: After the risk value of the third maneuvering option is calculated, the processor 110 may transmit, to the path planning circuitry 150, the calculated risk value of the third maneuvering option.

At 770: In some forms of the present disclosure, the processor may calculate each of the risk values associated with the first maneuvering option, the second maneuvering option, and the third maneuvering option, respectively. Based on each of the calculated risk values, the processor 110 may select a maneuvering option having the lowest risk value from among the first maneuvering option, the second maneuvering option, and the third maneuvering option.

At 780: The processor 110 may control the vehicle to drive according to the selected maneuvering option. In some forms of the present disclosure, the process 700 may be repeated on a regular interval (e.g., every 10 minutes), which may be predetermined.

The system and method for evaluating risk values associated with the object on the road may provide enhanced safety when it comes to the path planning of autonomous vehicles. For example, when the vehicle 200 is surrounded by the surrounding vehicle 210 and the following vehicle 220, swerving into another lane where it is already occupied by the surrounding vehicle 210 or making a sudden stop where maintaining a safe distance to the following vehicle 220 is not feasible would present higher risks to the vehicle 200 when the option of driving through the object 230 presents a low risk. As a result, having the option of driving through the object 230 for the vehicle 200 when the risk value associated with that option is very low may greatly increase safety for the vehicle 200 as well as the surrounding vehicle 210 and the following vehicle 220.

In addition, the present disclosure may be easily implemented in different types of vehicles as long as the vehicles are equipped with sensors (e.g., radar, LiDar, camera).

Furthermore, using the equation (the sum of each risk value associated with each feature where each risk value is calculated by multiplying the normalized value with the weighted parameter) would present a significant advantage in that it does not require excessive processing power to perform the calculation. As a result, the processor 110 in the vehicle 200 may use less processing power when calculating the total risk value associated with all present features, which would eventually contribute to the vehicle 200's overall system efficiency as the processing power is generally limited on the vehicle 200.

Some forms of the present disclosure may also be embodied as computer-readable code on a computer-readable recording medium. The computer-readable recording medium is any data storage device that can store data which can thereafter be read by a computer system. Examples of the computer-readable recording medium may include read-only memory (ROM), random-access memory (RAM), CD-ROMs, magnetic tapes, floppy disks, optical data storage devices, cloud storage device, and carrier waves (such as data transmission over the internet).

The methods, systems, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuits dies, or implemented in a Multiple Chip Module (MCM) of multiple integrated circuits dies in a common package, as examples.

The system and method may further include or access instructions for execution by the circuitry. The instructions may be stored in a tangible storage medium that is other than a transitory signal, such as flash memory, a Random Access Memory (RAM), a Read-Only Memory (ROM), an Erasable Programmable Read-Only Memory (EPROM); or on a magnetic or optical disc, such as a Compact Disc Read-Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
detecting, by a plurality of sensors, an object on a road that a vehicle travels, wherein each sensor of the plurality of sensors is configured to detect different types of the object;
after detecting the object on the road, classifying, by a processor, the object into an object type;
identifying, by the processor, a plurality of maneuvering options of the vehicle corresponding to the object type;
calculating, by the processor, risk values of each maneuvering option; and
selecting, by the processor, a maneuvering option of the plurality of maneuvering options, wherein a risk value of the selected maneuvering option is equal to or less than a predetermined risk value.

2. The method of claim 1, wherein identifying the plurality of maneuvering options comprises:
identifying the plurality of maneuvering options based on surrounding vehicles and structures detected by the plurality of sensors.

3. The method of claim 1, wherein identifying the plurality of maneuvering options comprises:
identifying the plurality of maneuvering options of the vehicle that includes at least one of:
a first maneuvering option of determining a new trajectory to avoid contact with the object;
a second maneuvering option of controlling the vehicle to a full stop before the object; or
a third maneuvering option of driving the vehicle through the object.

4. The method of claim 3, wherein selecting the maneuvering option comprises:
determining whether a risk value of the third maneuvering option is less than a risk value of the first maneuvering option or a risk value of the second maneuvering option; and
when it is determined that the risk value of the third maneuvering option is less than the risk value of the first maneuvering option or the risk value of the second maneuvering option, selecting the third maneuvering option.

5. The method of claim 3, wherein selecting the maneuvering option comprises:
comparing the risk values of the each maneuvering option; and
selecting the maneuvering option having a lowest risk value.

6. The method of claim 3, wherein selecting the maneuvering option comprises:
receiving, from the plurality of sensors, additional object information including a size of the object, whether the object is moving, and whether the object is a living material;
determining whether the size of the object is smaller than a predetermined threshold size; and
when it is determined that the size of the object is smaller than the predetermined threshold size, selecting the third maneuvering option.

7. The method of claim 6, wherein selecting the maneuvering option comprises:
when it is determined that the size of the object is greater than or equal to the predetermined threshold size, selecting either the first maneuvering option or the second maneuvering option.

8. The method of claim 6, wherein selecting the third maneuvering option further comprises:
calculating a risk value associated with the third maneuvering option by multiplying a first value with a second value, wherein the first value includes a normalized value associated with each detection feature of a plurality of detection features, and the second value includes a weighted parameter corresponding to the each detection feature;
determining whether the risk value of the third maneuvering option is less than the predetermined risk value; and
when it is determined that the risk value of the third maneuvering option is less than the predetermined risk value, selecting the third maneuvering option.

9. The method of clam 8, wherein selecting the third maneuvering option further comprises:
providing, to an artificial intelligence circuitry, a set of driving data to evaluate performance of each machine learning model of a plurality of machine learning models, wherein the artificial intelligence circuitry executed the plurality of machine learning models that have been trained with the driving data;
selecting a machine learning model satisfying a predetermined criterion; and
calculating the second value using the selected machine learning model.

10. The method of claim 1, wherein the method further comprises:
detecting, by the plurality of sensors, a material of the object;
after detecting the material of the object, classifying, by the processor, the object, into a material type;
identifying, by the processor, a plurality of maneuvering options of the vehicle corresponding to the material type; and
calculating, by the processor, the risk values of the each maneuvering option.

11. A system comprising:
a processor;
a plurality of sensors operatively connected to the processor, the plurality of sensors configured to:
detect an object on a road that a vehicle travels;
detect a material of the object; and
detect surrounding vehicles and structures; and
non-transitory memory storing instructions executable to evaluate risk values of each maneuvering option of a plurality of maneuvering options;
wherein the processor is configured to execute the instructions stored in the non-transitory memory to:
classify the object into an object type;
identify a plurality of maneuvering options of the vehicle corresponding to the object type;
calculate the risk values of the each maneuvering option; and
select a maneuvering option, wherein a risk value of the selected maneuvering option is equal to or less than a predetermined risk value.

12. The system of claim 11, wherein the processor is further configured to:
identify the plurality of maneuvering options based on the surrounding vehicles and the structures.

13. The system of claim 11, wherein, when identifying the plurality of maneuvering options, the processor is configured to:
identify the plurality of maneuvering options of the vehicle that includes at least one of:
a first maneuvering option of determining a new trajectory to avoid contact with the object;
a second maneuvering option of controlling the vehicle to a full stop before the object; or
a third maneuvering option of driving the vehicle through the object.

14. The system of claim 13, wherein, when selecting the maneuvering option, the processor is configured to:
determine whether a risk value of the third maneuvering option is less than a risk value of the first maneuvering option or a risk value of the second maneuvering option; and
when it is determined that the risk value of the third maneuvering option is less than the risk value of the first maneuvering option or the risk value of the second maneuvering option, select the third maneuvering option.

15. The system of claim 13, wherein, when selecting the maneuvering option, the processor is configured to:
compare the risk values of each maneuvering option; and
select the maneuvering option having a lowest risk value.

16. The system of claim 13, wherein, when selecting the maneuvering option, the processor is configured to:
receive, from the plurality of sensors, additional object information including a size of the object, whether the object is moving, and whether the object is a living material;
determine whether the size of the object is smaller than a predetermined threshold size; and
when it is determined that the size of the object is smaller than the predetermined threshold size, select the third maneuvering option.

17. The system of claim 16, wherein, when selecting the maneuvering option, the processor is configured to:
when it is determined that the size of the object is greater than or equal to the predetermined threshold size, select either the first maneuvering option or the second maneuvering option.

18. The system of claim 16, wherein, when selecting the third maneuvering option, the processor is further configured to:
calculate a risk value associated with the third maneuvering option by multiplying a first value with a second value, wherein the first value includes a normalized value associated with each detection feature of a plurality of detection features, and the second value includes a weighted parameter corresponding to the each detection feature;
determine whether the risk value of the third maneuvering option is less than the predetermined risk value; and
when it is determined that the risk value of the third maneuvering option is less than the predetermined risk value, select the third maneuvering option.

19. The system of claim 18, wherein the system further comprises:
an artificial intelligence circuitry operatively connected to the processor, the artificial intelligence circuitry configured to:
execute a plurality of machine learning models that have been trained with driving data;
evaluate performance of each machine learning model of the plurality of machine learning models using the driving data;
select a machine learning model satisfying a predetermined criterion; and
calculate the second value using the selected machine learning model.

20. The system of claim 11, wherein, when calculating the risk values of the each maneuvering option, the processor is configured to:
classify the object into a material type;
identifying a plurality of maneuvering options of the vehicle corresponding to the material type; and
calculate the risk values of the each maneuvering option.
